(19) United States
(12) Patent Application Publication
(10) Pub. No.: US 2024/0388344 A1
(43) Pub. Date: Nov. 21, 2024

(54) TECHNIQUES FOR JOINT REPORTING OF CHANNEL STATE INFORMATION AND CROSS-LINK INTERFERENCE

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Qian ZHANG, Basking Ridge, NJ (US)

(21) Appl. No.: 18/660,044

(22) Filed: May 9, 2024

Related U.S. Application Data
(60) Provisional application No. 63/502,403, filed on May 15, 2023.

(51) Int. Cl. H04B 7/06; H04B 17/309; H04B 17/318; H04L 5/14

(52) U.S. Cl. CPC H04B 7/0626; H04B 17/328; H04B 17/346; H04L 5/14

(57) ABSTRACT

Methods, systems, and devices for wireless communication are described. Generally, the techniques described herein may enable joint reporting of channel state information (CSI) and cross-link interference (CLI). For example, a network entity may transmit, to a user equipment (UE), a joint configuration indicative of a first set of resources associated with generation of one or more CSI metrics and a second set of resources associated with generation of one or more CLI metrics. As such, the UE may generate the one or more CSI metrics and one or more CLI metrics in accordance with the joint configuration and transmit a joint report indicative of the one or more CSI metrics and the one or more CLI metrics.

### CROSS REFERENCE

The present application for patent claims the benefit of U.S. Provisional Patent Application No. 63/502,403 by ABDELGHAFFAR et al., entitled “TECHNIQUES FOR JOINT REPORTING OF CHANNEL STATE INFORMATION AND CROSS-LINK INTERFERENCE,” filed May 15, 2023, assigned to the assignee hereof, and expressly incorporated by reference herein in its entirety.

### INTRODUCTION

The following relates to wireless communication, including techniques for joint reporting of channel state information (CSI) and cross-link interference (CLI).

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support joint reporting of channel state information (CSI) and cross-link interference (CLI). For example, a first network node, such as a network entity, may transmit, to a second network node, such as a user equipment (UE), a joint configuration indicative of at least a CSI resource setting and a CLI resource setting. The CSI resource setting may indicate a first set of resources associated with generation of CSI and the CLI resource setting may indicate a second set of resources for generation of CLI. In some examples, the first set of resources associated with CSI may be different than the second set of resources associated with CLI. Additionally, or alternatively, at least a subset of the first set of resources associated with CSI may be the same as the second set of resources associated with the CLI.

As such, the UE may measure the first set of resources or the first set of resources and the second set of resources to generate one or more CSI metrics and may measure the second set of resources to generate one or more CLI metrics. In some examples, the one or more CLI metrics may include one or more received signal strength indicators (RSSIs), one or more reference signal received powers (RSRPs), one or more signal to interference and noise ratios (SINRs), or any combination thereof. Additionally, or alternatively, the one or more CSI metrics may include one or more channel quality indicators (CQIs), one or more rank indicators (RIs), one or more pre-coding matrix indicators (PMIs), one or more CSI-reference signal reference indicators (CRIs), or any combination thereof. In such cases, the one or more CSI metrics may include explicit values of each CSI metric or may include a differential value of each CSI metric relative to one or more previously measured CSI metrics. As such, the UE may transmit a joint report indicating the one or more CSI metrics and the one or more CSI metrics.

A method for wireless communications at a network node is described. The method may include receiving a joint configuration indicative of first resources associated with generation of CSI information and second resources associated with generation of CLI information, generating the CSI information and the CLI information in accordance with the joint configuration, and transmitting a joint report indicative of the CSI information and the CLI information.

An apparatus for wireless communications at a network node is described. The apparatus may include a processor, memory coupled with the processor, and instructions stored in the memory. The instructions may be executable by the processor to cause the apparatus to receive a joint configuration indicative of first resources associated with generation of CSI information and second resources associated with generation of CLI information, generate the CSI information and the CLI information in accordance with the joint configuration, and transmit a joint report indicative of the CSI information and the CLI information.

Another apparatus for wireless communications at a network node is described. The apparatus may include means for receiving a joint configuration indicative of first resources associated with generation of CSI information and second resources associated with generation of CLI information, means for generating the CSI information and the CLI information in accordance with the joint configuration, and means for transmitting a joint report indicative of the CSI information and the CLI information.

A non-transitory computer-readable medium storing code for wireless communications at a network node is described. The code may include instructions executable by a processor to receive a joint configuration indicative of first resources associated with generation of CSI information and second resources associated with generation of CLI information, generate the CSI information and the CLI information in accordance with the joint configuration, and transmit a joint report indicative of the CSI information and the CLI information.

In some examples of the method, apparatuses, and non-transitory computer-readable medium described herein, generating the CSI information and the CLI information in accordance with the joint configuration may include operations, features, means, or instructions for measuring the first resources to generate one or more CSI metrics, where the CSI information includes the one or more CSI metrics and measuring the second resources to generate one or more CLI metrics, where the CLI information includes the one or more CLI metrics.

In some examples of the method, apparatuses, and non-transitory computer-readable medium described herein, the one or more CLI metrics includes one or more RSSIs, one or more RSRPs, one or more SINRs, or any combination thereof.

In some examples of the method, apparatuses, and non-transitory computer-readable medium described herein, the one or more CSI metrics includes one or more CQIs indicators, one or more RIs, one or more PMIs, one or more CRIs, or any combination thereof.

In some examples of the method, apparatuses, and non-transitory computer-readable medium described herein, the joint configuration includes a wideband format indicator or a sub-band format indicator associated with generation of the one or more CLI metrics.

In some examples of the method, apparatuses, and non-transitory computer-readable medium described herein, measuring the second resources may include operations, features, means, or instructions for measuring the second resources over a wideband to generate a first CLI metric associated with the wideband based on the joint configuration including the wideband format indicator, where the one or more CLI metrics includes the first CLI metric.

In some examples of the method, apparatuses, and non-transitory computer-readable medium described herein, measuring the second resources may include operations, features, means, or instructions for measuring the second resources over a set of sub-bands to generate a set of first CLI metrics associated with each sub-band of the set of sub-bands based on the joint configuration including the sub-band format indicator, where the one or more CLI metrics includes the set of first CLI metrics.

In some examples of the method, apparatuses, and non-transitory computer-readable medium described herein, generating the CSI information and the CLI information in accordance with the joint configuration may include operations, features, means, or instructions for measuring the first resources and the second resources to generate one or more CSI metrics, where the CSI information includes the one or more CSI metrics and measuring the second resources to generate one or more CLI metrics, where the CLI information includes the one or more CLI metrics.

In some examples of the method, apparatuses, and non-transitory computer-readable medium described herein, the CSI information may be first CSI information associated with a first slot and the joint report includes the first CSI information as one or more differential values with respect to second CSI information associated with a second slot that may be prior to the first slot.

In some examples of the method, apparatuses, and non-transitory computer-readable medium described herein, the first slot may be a SBFD slot and the second slot may be a non-SBFD slot.

In some examples of the method, apparatuses, and non-transitory computer-readable medium described herein, the first slot may be an asynchronous slot and the second slot may be a synchronous slot.

In some examples of the method, apparatuses, and non-transitory computer-readable medium described herein, the CLI information may be first CLI information associated with a first slot and the joint report includes the first CLI information as one or more differential values with respect to second CLI information associated with a second slot that may be prior to the first slot.

In some examples of the method, apparatuses, and non-transitory computer-readable medium described herein, at least a subset of the first resources may be the same as the second resources.

In some examples of the method, apparatuses, and non-transitory computer-readable medium described herein, the first resources may be different than the second resources.

A method for wireless communications at a network node is described. The method may include transmitting a joint configuration indicative of first resources associated with generation of CSI information and second resources associated with generation of CLI information and receiving a joint report indicative of the CSI information and the CLI information in accordance with the joint configuration.

An apparatus for wireless communications at a network node is described. The apparatus may include a processor, memory coupled with the processor, and instructions stored in the memory. The instructions may be executable by the processor to cause the apparatus to transmit a joint configuration indicative of first resources associated with generation of CSI information and second resources associated with generation of CLI information and receive a joint report indicative of the CSI information and the CLI information in accordance with the joint configuration.

Another apparatus for wireless communications at a network node is described. The apparatus may include means for transmitting a joint configuration indicative of first resources associated with generation of CSI information and second resources associated with generation of CLI information and means for receiving a joint report indicative of the CSI information and the CLI information in accordance with the joint configuration.

A non-transitory computer-readable medium storing code for wireless communications at a network node is described. The code may include instructions executable by a processor to transmit a joint configuration indicative of first resources associated with generation of CSI information and second resources associated with generation of CLI information and receive a joint report indicative of the CSI information and the CLI information in accordance with the joint configuration.

In some examples of the method, apparatuses, and non-transitory computer-readable medium described herein, the CSI information includes one or more CSI metrics and the CLI information includes one or more CLI metrics.

In some examples of the method, apparatuses, and non-transitory computer-readable medium described herein, the one or more CLI metrics includes one or more RSSIs, one or more RSRPs, one or more SINRs, or any combination thereof.

In some examples of the method, apparatuses, and non-transitory computer-readable medium described herein, the one or more CSI metrics includes one or more CQIs indicators, one or more RIs, one or more PMIs, one or more CRIs, or any combination thereof.

In some examples of the method, apparatuses, and non-transitory computer-readable medium described herein, the joint configuration includes a wideband format indicator or a sub-band format indicator associated with generation of the one or more CLI metrics.

In some examples of the method, apparatuses, and non-transitory computer-readable medium described herein, the first resources may be associated with a wideband and the one or more CLI metrics includes a first CSI metric associated with the wideband based on the joint configuration including the wideband format indicator.

In some examples of the method, apparatuses, and non-transitory computer-readable medium described herein, the first resources may be associated with a set of sub-bands and the one or more CLI metrics includes a first CSI metric associated with each sub-band based on the joint configuration including the sub-band format indicator.

In some examples of the method, apparatuses, and non-transitory computer-readable medium described herein, the CSI information may be first CSI information associated with a first slot and the joint report includes the first CSI information as one or more differential values with respect to second CSI information associated with a second slot that may be prior to the first slot.

In some examples of the method, apparatuses, and non-transitory computer-readable medium described herein, the first slot may be a SBFD slot and the second slot may be a non-SBFD slot.

In some examples of the method, apparatuses, and non-transitory computer-readable medium described herein, the first slot may be an asynchronous slot and the second slot may be a synchronous slot.

In some examples of the method, apparatuses, and non-transitory computer-readable medium described herein, the CLI information may be first CLI information associated with a first slot and the joint report includes the first CLI information as one or more differential values with respect to second CLI information associated with a second slot that may be prior to the first slot.

In some examples of the method, apparatuses, and non-transitory computer-readable medium described herein, at least a subset of the first resources may be the same as the second resources.

In some examples of the method, apparatuses, and non-transitory computer-readable medium described herein, the first resources may be different than the second resources.

### BRIEF DESCRIPTION OF THE DRAWINGS

FIG. 1 shows an example of a wireless communication system that supports techniques for joint reporting of channel state information (CSI) and cross-link interference (CLI) in accordance with one or more aspects of the present disclosure.

FIG. 2 shows an example of a wireless communication system that supports techniques for joint reporting of CSI and CLI in accordance with one or more aspects of the present disclosure.

FIG. 3 shows an example of a joint configuration that supports techniques for joint reporting of CSI and CLI in accordance with one or more aspects of the present disclosure.

FIG. 4 shows an example of a process flow that supports techniques for joint reporting of CSI and CLI in accordance with one or more aspects of the present disclosure.

FIGS. 5 and 6 show block diagrams of devices that support techniques for joint reporting of CSI and CLI in accordance with one or more aspects of the present disclosure.

FIG. 7 shows a block diagram of a communications manager that supports techniques for joint reporting of CSI and CLI in accordance with one or more aspects of the present disclosure.

FIG. 8 shows a diagram of a system including a device that supports techniques for joint reporting of CSI and CLI in accordance with one or more aspects of the present disclosure.

FIGS. 9 and 10 show block diagrams of devices that support techniques for joint reporting of CSI and CLI in accordance with one or more aspects of the present disclosure.

FIG. 11 shows a block diagram of a communications manager that supports techniques for joint reporting of CSI and CLI in accordance with one or more aspects of the present disclosure.

FIG. 12 shows a diagram of a system including a device that supports techniques for joint reporting of CSI and CLI in accordance with one or more aspects of the present disclosure.

FIGS. 13 and 14 show flowcharts illustrating methods that support techniques for joint reporting of CSI and CLI in accordance with one or more aspects of the present disclosure.

### DETAILED DESCRIPTION

Some wireless communication systems may support reporting, by a user equipment (UE), of cross-link interference (CLI) measurements, as well as channel state information (CSI) measurements, to a network entity. However, CLI measurement reporting may be associated with a layer 3 (L3) of the UE while CSI measurement reporting may be associated with a layer 1 (L1) or a layer 2 (L2) of the UE. In such cases, the network entity may transmit, to the UE, a first configuration associated with the CLI measurement reporting and a second, separate, configuration associated with the CSI measurement reporting. Additionally, the UE may transmit a CSI report based on the first configuration and a separate CLI report based on the second configuration, thus increasing overhead and resource utilization.

Accordingly, techniques described herein may support joint configuration and joint reporting of CSI and CLI (e.g., at L1/L2) to reduce overhead and resource utilization. In other words, a network entity may transmit, to a UE, a joint configuration indicating at least a CSI resource setting and a CLI resource setting, and a report setting including joint reporting of the CSI and CLI measurements quantities. In some examples, the CLI resource setting may indicate one or more resources for CLI measurement that are different than one or more resources for CSI measurement, as indicated in the CSI resource setting. Alternatively, the CLI resource setting may indicate for the UE to use at least a portion of the one or more resources for CSI measurement also for CLI measurement. Accordingly, the UE may generate CSI information and CLI information based on the respective resource settings and transmit a joint report including both the CSI information and the CLI information. In some examples, the joint report may include one or more CLI metrics for joint reporting of the CLI information (e.g., as indicated in the joint configuration), such as CLI received signal strength indicators (RSSIs), one or more CLI reference signal received powers (RSRPs), or one or more CLI signal to interference and noise ratios (SINRs), which may be set to wideband or sub-band. Additionally, the joint report may include one or more CSI metrics for joint reporting of the CSI information, where the one or more CSI metrics may include an explicit value of the CSI metric or may indicate a differential value of the CSI metric relative to a previously measured CSI metric.

Aspects of the disclosure are initially described in the context of wireless communication systems. Aspects of the disclosure are then described in the context of a configuration and a process flow. Aspects of the disclosure are further illustrated by and described with reference to apparatus diagrams, system diagrams, and flowcharts that relate to techniques for joint reporting of channel state information and cross-link interference.

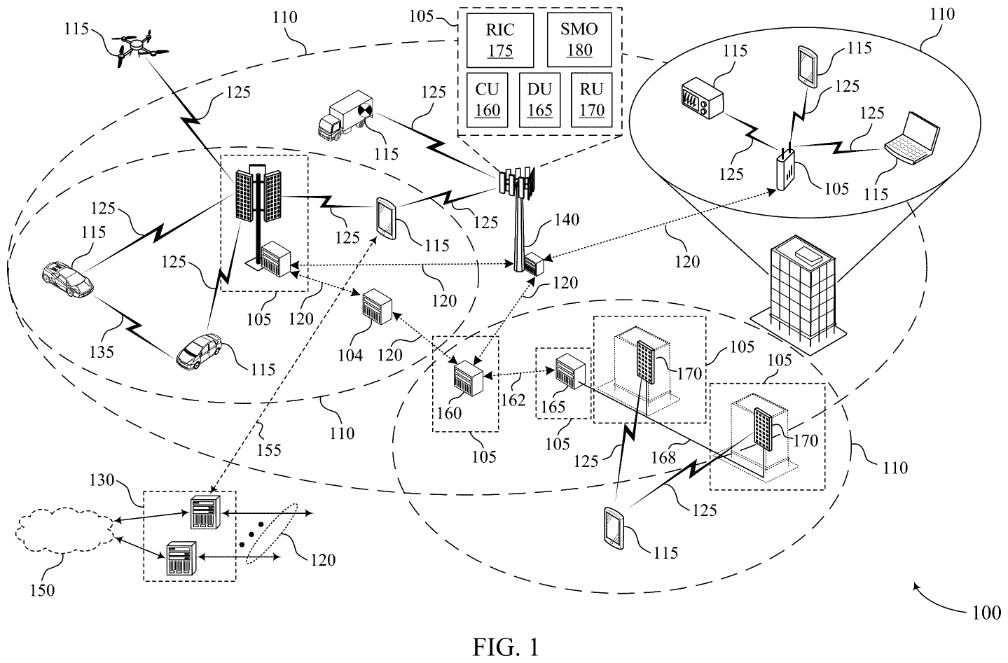

FIG. 1 shows an example of a wireless communication system 100 that supports techniques for joint reporting of CSI and CLI in accordance with one or more aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communication systems (e.g., wireless communication system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for joint reporting of CSI and CLI as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communication resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communication system 100 may support joint configuration and joint reporting of CSI and CLI to reduce overhead and resource utilization. In other words, a network entity 105 may transmit, to a UE 115, a joint configuration indicating at least a CSI resource setting and a CLI resource setting. In some examples, the CLI resource setting may indicate one or more resources for CLI measurement that are different than one or more resources for CSI measurement, as indicated in the CSI resource setting. Alternatively, the CLI resource setting may indicate for the UE to use at least a portion of the one or more resources for CSI measurement also for CLI measurement. Accordingly, the UE 115 may generate one or more CSI metrics and one or more CLI metrics based on the respective resource settings and transmit a joint report including both the one or more CSI metrics and the one or more CLI metrics. In some examples, the one or more CLI metrics for joint reporting of the CLI information (e.g., as indicated in the joint configuration) may include one or more CLI RSSIs, one or more CLI RSRPs, or one or more CLI SINR, which may be set to wideband or sub-band. Additionally, the one or more CSI metrics may include one or more CQIs, one or more RIs, one or more PMIs, one or more CRSs, or any combination thereof. In such cases, the one or more CSI metrics may include explicit values of each of the one or more CSI metrics or may include a differential value of each of the one or more CSI metrics relative to one or more previously generates CSI metrics.

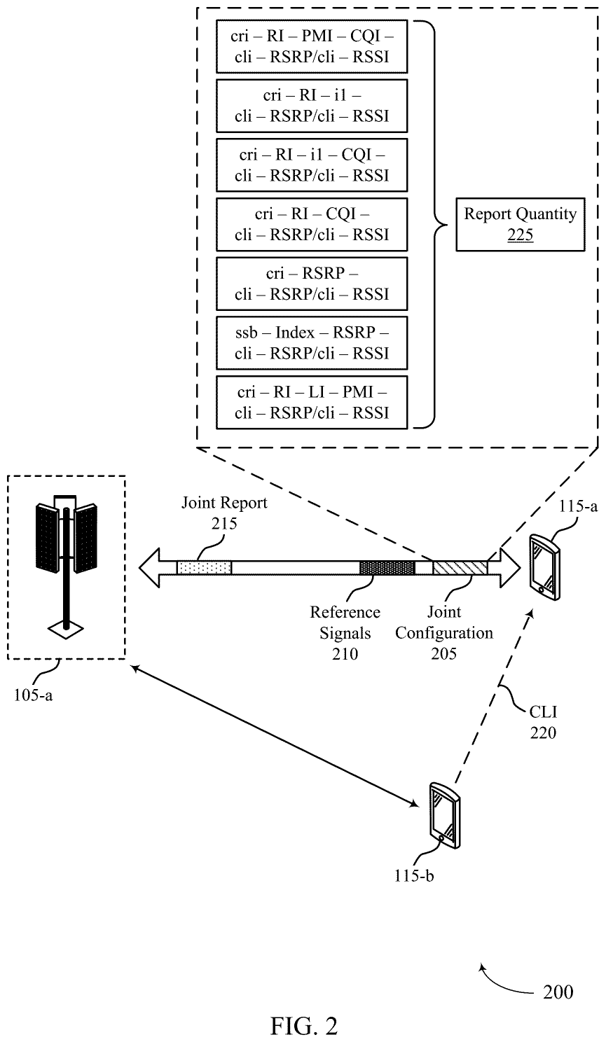

FIG. 2 shows an example of a wireless communication system 200 that supports techniques for joint reporting of CSI and CLI in accordance with one or more aspects of the present disclosure. In some cases, the wireless communication system 200 may implement or be implemented by aspects of the wireless communication system 100. For example, the wireless communication system 200 may include one or more UEs 115 (e.g., a UE 115-a and a UE 115-b) and one or more network entities 105 (e.g., a network entity 105-a), which may be examples of the corresponding devices as described with reference to FIG. 1.

Some wireless communication systems, such as the wireless communication system 200, may support reporting, by a UE 115, such as the UE 115-a, of CLI 220 (e.g., due to communications by a UE 115-b), as well as CSI, to a network entity 105, such as the network entity 105-a. However, CLI reporting may be associated with L3 of the UE 115-a while CSI reporting may be associated with L1 or L2 of the UE 115-a. In such cases, the network entity 105-a may transmit, to the UE 115-a, a first configuration associated with the CLI reporting and a second, separate, configuration associated with the CSI reporting. Additionally, the UE 115-a may transmit a CSI report based on the first configuration and a separate CLI report based on the second configuration, thus increasing overhead and resource utilization.

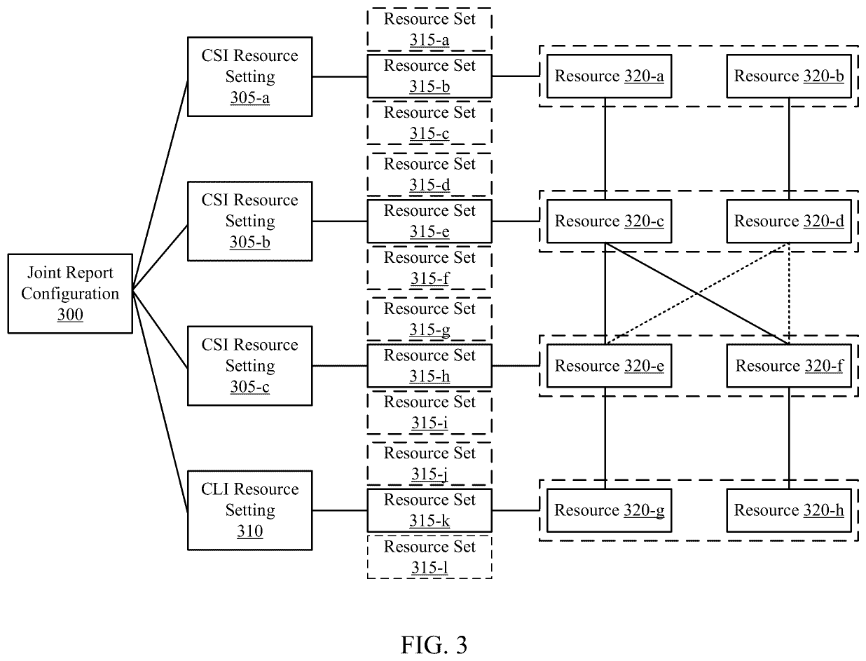

Accordingly, techniques described herein may support joint configuration and joint reporting of CSI and CLI 220 (e.g., at L1/L2) to reduce overhead and resource utilization. In other words, the network entity 105-a may transmit, to the UE 115-a, a joint configuration 205 indicating at least a CSI resource setting and a CLI resource setting, as described with reference to FIG. 3. For example, the joint configuration may indicate a first CSI resource setting, which may be referred to as a channel measurement report (CMR) resource setting (e.g., a CSI resource setting 305-a as described with reference to FIG. 3), a second CSI resource setting, which may be referred to as a CSI-interference measurement (CSI-IM) resource setting (e.g., a CSI resource setting 305-b as described with reference to FIG. 3), a third CSI resource setting, which may be referred to as a non-zero-power-interference measurement report (NZP-IMR) resource setting (e.g., a CSI resource setting 305-c as described with reference to FIG. 3), and a CLI resource setting (e.g., a CLI resource setting 310). In such cases, each resource setting may be associated with a set of resources. That is, the CMR resource setting may be associated with a first set of resources, which may be referred to as CMR resources, the CSI-IMR resource setting may be associated with a second set of resources, which may be referred to as CSI-IM resources, the NZP-IMR resource setting may be associated with a third set of resources, which may be referred to as NZP-IMR-resources, and the CLI resource setting may be associated with a fourth set of resources, which may be referred to as CLI resources.

In some examples, the fourth set of resources associated with the CLI resource setting may be different than the sets of resources (e.g., the first set of resources, the second set of resources, and the third set of resources) associated with the CSI resource settings (e.g., the CLI resources may be a new, dedicated IMR). For example, the resources for CSI and CLI measurement may be configured according to Joint Configuration 1:

```
CSI-ReportConfig ::=
  reportConfigID
  carrier
  resourcesForChannelMeasurement
  csi-IM-ResourcesForInterference
  nzp-CSI-RS-ResourcesForInterference
  cli-ResourceForInterference
    srs-ResourceSet
    rssi-ResourceSet
Joint Configuration 1
```

where CSI-ReportConfig represents the joint configuration 205, reportConfigID indicates an identifier associated with the joint configuration 205, carrier indicates a serving cell identifier associated with the network entity 105-a, resourcesForChannelMeasurement indicates the CMR resources associated with CMR resource setting, csi-IM-ResourcesForInterference indicates the CSI-IM resources associated with the CSI-IM resource setting, nzp-CSI-RS-ResourcesForIntereference indicates the NZP-IMR resources associated with the NZP-IMR resource setting, and cli-ResourceForInterference indicates the CLI resources associated with the CLI resource setting. Further, the cli-ResourceForInterference may indicate CLI resources for sounding reference signals-based (SRSs) RSRP measurements, represented by srs-ResourceSet, or CLI resources for RSSI measurement, represented by rssi-ResourceSet (e.g., the Joint Configuration 1 will indicate either srs-ResourceSet or rssi-ResourceSet).

Additionally, or alternatively, at least a portion of the CLI resources associated with the CLI resource setting may be the same as one or more of the sets of resources (e.g., CMR resources, CSI-IM resources, NZP-IMR resources) associated with the CSI resource settings (e.g., existing IMRs may be reused for CLI resources). For example, the CLI resources may be for RSSI measurement, such that the CMR resources may be the same as the CLI resources (e.g., the CMR resources may be used for CMR and CLI-RSSI). Additionally, or alternatively, the CLI resources may be used for SRS-based RSRP measurement, such that the CSI-IM resources may be the same as the CLI resources (e.g., the CSI-IM resources may be used for CSI-IM and CLI-RSSI). In such cases, the resources for CSI and CLI measurement may be configured according to Joint Configuration Joint Configuration 2:

```
CSI-ReportConfig ::=
  reportConfigID
  carrier
  resourcesForChannelMeasurement
    CSI-ResourceConfigID,
    cli-ResourceForInterference
  csi-IM-ResourcesForInterference
    CSI-ResourceConfigID
    cli-ResourceForInterference
  nzp-CSI-RS-ResourcesForInterference
Joint Configuration 2
```

where CSI-ResourceConfigId indicates an identifier associated with the CMR resources, CSI-ResourceConfigId indicates an identifier associated with the CSI-IM resources. As discussed previously, the CLI resources may be for SRS-based RSRP measurement or for RSSI measurement. As such, the Joint Configuration 2 may include cli-ResourceForInterference under resourcesForChannelMeasurement when the CLI resources are for RSSI measurement and may include cli-ResourceForInterference under csi-IM-ResourcesForInterference when the CLI resources are for SRS-based RSRP measurement (e.g., CSI-ReportConfig may not include two instances of cli-ResourceForInterference). As discussed previously, the cli-ResourceForInterference may indicate CLI resources for SRS-based RSRP measurement via srs-ResourceSet or CLI resources for RSSI measurement via rssi-ResourceSet.

In another example, the resources for CSI and CLI measurement may be configured according to a CSI resource configuration (e.g., as indicated by a CSI-ResourceConfigId) to Joint Configuration 3:

```
CSI-ReportConfig ::=
  reportConfigID
  carrier
  resourcesForChannelMeasurement
  csi-IM-ResourcesForInterference
  nzp-CSI-RS-ResourcesForInterference
  cli-ResourceForInterference
CSI-ResourceConfig ::=
  csi-ResourceConfigId
  csi-RS-ResourceSetList
    nzp-CSI-RS-SSB
      nzp-CSI-RS-ResourceSetList
      csi-SSB-ResourceSetList
    csi-IM-ResourceSetList
    srs-ResourceSet
    rssi-ResourceSet
CSI-ResourceConfig ::=
  csi-ResourceConfigId
  csi-RS-ResourceSetList
    nzp-CSI-RS-SSB-SRS
      nzp-CSI-RS-ResourceSetList
      csi-SSB-ResourceSetList
      srs-ResourceSet
    csi-IM-ResourceSetList
    rssi-ResourceSet
Joint Configuration 3
```

In such cases, the CMR resources (e.g., indicated via resourcesForChannelMeasurement), the CSI-IM resources (e.g., indicated via csi-IM-ResourcesForInterference), the NZP-IMR resources (e.g., indicated via nzp-CSI-RS-ResourcesForIntereference), and the CLI resources (e.g., indicated via cli-ResourceForInterference) may all be configured based on a CSI resource configuration, represented by CSI-ResourceConfig. In a first example, as indicated via the second block in the Joint Configuration 3, the CLI resources (e.g., srs-ResourceSet or rssi-ResourceSet) may be different than the CMR resources (csi-SSB-ResourceSetList), the CSI-IM resources (e.g., csi-IM-ResourceSetList), and the NZP-IMR resources (e.g., nzp-CSI-RS-ResourceSetList). In a second example, as indicated via the third block in the Joint Configuration 3, the CLI resources may be for SRS-based RSRP measurement and may be the same as the CSI-IM resources or may be for RSSI measurement and may be the same as the CMR resources.

As such, the UE 115-a may measure reference signals 210 associated with the CMR resources, the CSI-IM resources, the NZP-IMR resources, and the CLI resource to generate one or more CSI metrics and one or more CLI metrics, respectively. Additionally the UE 115-a may transmit, to the network entity 105-a, a joint report 215 indicating the one or more CSI metrics and the one or more CLI metrics.

In some examples, the joint configuration 205 may indicate the one or more CLI metrics (e.g., new report quantities) to be reported by the UE 115-a. For example, the one or more CLI metrics may include one or more CLI-RSSIs (e.g., indicated via cli-RSSI), one or more CLI-RSRPs (e.g., indicated via cli-RSRP), one or more CLI-SINRs (e.g., indicated via cli-SINR), or any combination thereof. In some examples, each CLI metric may be set to wideband or sub-band. That is, a format indicator (e.g., cli-FormatIndicator) in the joint configuration 205 (e.g., indicated via reportFreqConfiguration) may indicate for the UE 115-a to measure the one or more CLI metrics over a wideband or over a set of sub-bands. For example, when the format indicator is set to wideband, the UE 115-a may measure the reference signals 210 associated with the CLI resource setting over a wideband associated with the CLI resources and the one or more CLI metrics may include a first CLI metric associated with the wideband. Conversely, when the format indicator is set to sub-band, the UE 115-a may measure the reference signals 210 associated with the CLI resource setting over a set of sub-bands associated with the CLI and the one or more CLI metrics may include a set of second CLI metric associated with each sub-band of the set of sub-bands. Similarly, each CSI metric may be set to wideband or sub-band based on respective format indicators (e.g., cqi-FormatIndictor or pmi-FormatIndicator) in the joint configuration 205.

Additionally, or alternatively, the joint configuration 205 may indicate the one or more CSI metrics to be reported by the UE 115-a. For example, the one or more CSI metrics may include one or more CQIs, one or more RIs, one or more PMIs, one or more CRIs, or any combination thereof. In some examples, the one or more CSI metrics may include an explicit value of each of the one or more CSI metrics (e.g., similar to legacy configurations). In some other examples, the one or more CSI metrics may include a differential value of each of the one or more CSI metrics (e.g., ACQI, ARI, APMI, ACRI). In other words, the one or more CSI metrics may be compressed CSI metrics with reference to one or more previous CSI metrics generate (e.g., measured) without CLI (e.g., to reduce payload reporting). For example, the UE 115-a may transmit a first joint report 215 (e.g., persistent or semi-persistent CSI report configured to report CSI and CLI) associated with a first slot, where the first joint report 215 indicates no CLI (e.g., via the one or more CLI metrics). As such, the UE 115-a may transmit a second joint report 215 associated with a second slot (e.g., occurring after the first slot), where the second slot indicates differential values of the one or more CSI metrics relative to the explicit values of the one or more CSI metrics (e.g., latest reported one or more CSI metrics) in the first joint report. In such cases, the first slot may be a non-sub-band full duplex (SBFD) slot or an synchronous slot and the second slot may be an SBFD slot or an asynchronous slot, respectively. The one or more CLI metrics may similarly be reported as explicit values or differential values.

In some examples, the network entity 105-a may indicate the one or more CSI metrics, the one or more CLI metrics, or both, via a report quantity 225 (e.g., reportQuantity) in the joint configuration 205. That is, the report quantity 225 may indicate the one or more CSI metrics, the one or more CLI metrics, or both, to be reported by the UE 115-a. For example, the report quantity 225 may indicate (e.g., via RRC) the one or more CSI metrics to be reported by the UE 115-a, as well as whether the UE 115-a should report RSRP for CLI (e.g., via inclusion of cli-RSRP) or RSSI for CLI (e.g., via inclusion of cli-RSSI). As an illustrative example, the report quantity 225 may indicate any of the following combinations of CSI metrics and CLI metrics: cri-RI-PMI-CQI-cli-RSRP/cli-RSSI, cri-RI-il-cli-RSRP/cli-RSSI, cri-RI-il-CQI-cli-RSRP/cli-RSSI, cri-RI-CQI-cli-RSRP/cli-RSSI, cri-RSRP-cli-RSRP/cli-RSSI, ssb-Index-RSRP-cli-RSRP/cli-RSSI, or cri-RI-LI-PMI-cli-RSRP/cli-RSSI.

FIG. 3 shows an example of a joint configuration 300 that supports techniques for joint reporting of CSI and CLI in accordance with one or more aspects of the present disclosure. In some cases, the joint configuration 300 may implement or be implemented by aspects of the wireless communication system 100, the wireless communication system 200, or both. For example, the joint configuration 300 may be implemented by one or more UEs 115 and one or more network entities 105, which may be examples of the corresponding devices as described with reference to FIG. 1.

As described with reference to FIG. 2, a network entity 105 may transmit, to a UE 115, a joint configuration 300 (e.g., a joint configuration 205 with reference to FIG. 2) for joint reporting of CSI metrics (e.g., one or more CSI metrics) and CLI metrics (e.g., one or more CLI metrics). That is, the joint configuration 300 (e.g., CSI-ReportConfig) may be configured (e.g., linked) with multiple resource settings (e.g., up to 4 resource settings). For example, the multiple resource settings may include a CSI resource setting 305-a, a CSI resource setting 305-b, a CSI resource setting 305-c, and a CLI resource setting 310.

The CSI resource setting 305-a may be a NZP CSI-RS resource setting for CMR and may be referred to as a CMR resource setting 305-a. The CSI resource setting 305-b may be a CSI-RS resource setting for IM and may be referred to as a CSI-IM resource setting 305-b. The CSI resource setting 305-c may be a NZP CSI-RS resource setting for IMR and may be referred to as an NZP-IMR resource setting 305-c.

Additionally, each of the CSI resource settings 305 and the CLI resource setting 310 may indicate multiple resource sets 315 indicating resources 320 over which the UE 115 may receive a reference signal for measurement of the respective CSI metrics or CLI metrics. For example, the CMR resource setting 305-a may indicate a resource set 315-a (e.g., an NZP CMR resource set 315-a), a resource set 315-b (e.g., an NZP CMR resource set 315-b), and a resource set 315-c (e.g., an NZP CMR resource set 315-c). Similarly, the CSI-IM resource setting 305-b may indicate a resource set 315-d (e.g., a CSI-IM resource set 315-d), a resource set 315-e (e.g., a CSI-IM resource set 315-e), and a resource set 315-f (e.g., a CSI-IM resource set 315-f). Similarly, the NZP-IMR resource setting 305-c may indicate a resource set 315-g (e.g., an NZP-IMR resource set 315-g), a resource set 315-h (e.g., an NZP-IMR resource set 315-h), and a resource set 315-i (e.g., an NZP-IMR resource set 315-i). Additionally, the CLI resource setting 310 may indicate a resource set 315-j (e.g., a CLI resource set 315-j), a resource set 315-k (e.g., a CLI resource set 315-k), and a resource set 315-1 (e.g., a CLI resource set 315-1).

Further, each resource set 315 may include one or more resources 320. That is, the UE 115 may select a resource set 315 for each of the CSI resource settings 305 and the CLI resource setting 310 and may measure the one or more resources 320 associated with each selected resource set 315 to generate respective CSI metrics or CLI metrics. For example, the UE 115 may select the resource set 315-b indicated by the CSI resource setting 305-a. As such, the UE 115 may measure a resource 320-a (e.g., an NZP CMR resource 320-a) and a resource 320-b (e.g., an NZP CMR resource 320-b) associated with the resource set 315-b to generate one or more CSI metrics for CMR. Similarly, the UE 115 may select the resource set 315-e indicated by the CSI resource setting 305-b and may measure a resource 320-c (e.g., a CSI-IM resource 320-c) and a resource 320-d (e.g., a CSI-IM resource 320-d) associated with the resource set 315-e to generate one or more CSI metrics for CSI-IM. Similarly, the UE 115 may select the resource set 315-h indicated by the CSI resource setting 305-c and may measure a resource 320-e (e.g., an NZP-IMR resource 320-c) and a resource 320-f (e.g., an NZP-IMR resource 320-f) associated with the resource set 315-h to generate CSI metrics for NZP-IMR. Similarly, the UE 115 may select the resource set 315-k indicated by the CLI resource setting 310 and may measure a resource 320-g (e.g., a CLI resource 320-g) and a resource 320-h (e.g., a CLI resource 320-h) associated with the resource set 315-k to generate one or more CLI metrics. In some examples, the resource 320-g and the resource 320-h may be for SRS-based RSRP measurement or RSSI measurement.

In some examples, one or more associations may exist between the resources 320. For example, the resource 320-a and the resource 320-b may be associated with the resource 320-c and the resource 320-d, respectively. Additionally, the resource 320-c and the resource 320-d may each be associated with the resource 320-e and the resource 320-f (e.g., each CMR resource 320 may be associated with all NZP IMR resources 320 collectively). Additionally, the resource 320-e and the resource 320-f may be associated with the resource 320-g and the resource 320-h, respectively (e.g., each CMR resource 320 may be associated with all CLI resources 320).

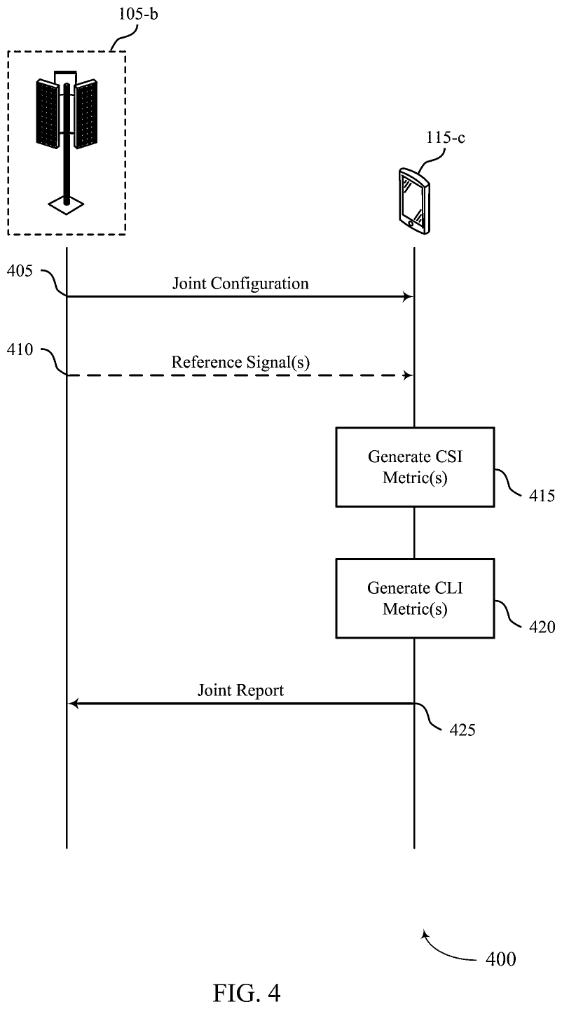

FIG. 4 shows an example of a process flow 400 that supports techniques for joint reporting of CSI and CLI in accordance with one or more aspects of the present disclosure. In some cases, the process flow 400 may implement or be implemented by aspects of the wireless communication system 100, the wireless communication system 200, the joint configuration 300, or any combination thereof. For example, the process flow 400 may be implemented by one or more UEs 115 (e.g., a UE 115-c) and one or more network entities 105 (e.g., a network entity 105-b), which may be examples of the corresponding devices as described with reference to FIG. 1.

At 405, the network entity 105-b may transmit, to the UE 115-c, a joint configuration indicative of first resources associated with generation of CSI information and second resources associated with generation of CLI information. The first resources may be indicated via one or more CSI resource settings and the second resources may be indicated via one or more CLI resource settings. In some examples, at least a portion of the first resources may be the same as the second resource. Additionally, or alternatively, the first resources may be different than the second resources. In some examples, the joint configuration may include a wideband format indicator or a sub-band format indicator associated with generation of the one or more CSI metrics, the one or more CLI metrics, or both.

In some examples, at 410, the network entity 105-b may transmit one or more reference signal via the first resources and the second resources.

At 415, the UE 115-c may generate the CSI information in accordance with the joint configuration. That is, the UE 115-c may measure the first resources or the first resources and the second resources (e.g., the reference signals transmitted via the first resources or via the first resources and the second resources) to generate one or more CSI metrics, where the CSI information includes the one or more CSI metrics. The one or more CSI metrics may include one or more CQIs, one or more RIs, one or more PMIs, one or more CRIs, or any combination thereof.

At 420, the UE 115-c may generate the CLI information in accordance with the joint configuration. That is, the UE 115-c may measure the second resources (e.g., the reference signals transmitted via the second resources) to generate one or more CLI metrics, where the CLI information includes the one or more CSI metrics. The one or more CLI metrics may include one or more RSSIs, one or more RSRPs, one or more SINRs, or any combination thereof.

In some examples, the UE 115-c may measure the second resources over a wideband to generate a first CLI metric (e.g., of the one or more CLI metrics) associated with the wideband based on the joint configuration including the wideband format indicator. In some other examples, the UE 115-c may measure the second resources over a set of sub-bands to generate a set of second CLI metrics (e.g., of the one or more CLI metrics) associated with each sub-band of the set of sub-bands based on the joint configuration including the sub-band format indicator

At 425, the UE 115-c may transmit, to the network entity 105-b, a joint report indicative of the CSI information and the CLI information. That is, the joint report may indicate the one or more CSI metrics and the one or more CLI metrics.

In some examples, the one or more CSI metrics may be reported as explicit values. That is, each of the one or more CSI metrics may indicate an explicit value of the respective CSI metric. Additionally, or alternatively, the one or more CSI metrics may be reported as differential values with respect to one or more previously reported CSI metrics. That is, the UE 115-c may previously report one or more second CSI metrics (e.g., via a second joint report or a CSI report) associated with a first slot, where the one or more second CSI metrics indicate (e.g., include) explicit values of the one or more second CSI metrics. As such, the one or more CSI metrics (e.g., reported in the joint report) may be associated with a second slot, occurring after the first slot, and may be reported as one or more differential values (e.g., deltas) with respect to the one or more second CSI metrics. For example, the one or more second CSI metrics may include a first (e.g., explicit) value of a CQI and the one or more CSI metrics may include a differential value of the CQI relative to the first value. In such cases, the first slot may be a non-SBFD slot or an asynchronous slot (e.g., associated with no CLI) and the second slot may be an SNFD slot or a synchronous slot.

Additionally, or alternatively, the one or more CLI metrics may be reported as explicit values. That is, each of the one or more CLI metrics may indicate an explicit value of the respective CLI metric. Additionally, or alternatively, the one or more CLI metrics may be reported as differential values with respect to one or more previously reported CLI metrics. That is, the UE 115-c may previously report one or more second CLI metrics (e.g., via a third joint report) associated with a third slot, where the one or more second CLI metrics indicate (e.g., include) explicit values of the one or more second CLI metrics. As such, the one or more CLI metrics (e.g., reported in the joint report) may be associated with a fourth slot, occurring after the third slot, and may be reported as one or more differential values (e.g., deltas) with respect to the one or more second CLI metrics. For example, the one or more second CLI metrics may include a first (e.g., explicit) value of a CLI-RSSI and the one or more CLI metrics may include a differential value of the CLI-RSSI relative to the first value. In such cases, the third slot may be associated with a first level of CLI below a threshold (e.g., minimal CLI) and the fourth slot may be associated with a second level of CLI above the threshold (e.g., such that a difference between the first level of CLI and the second level of CLI enables reporting of differential values).

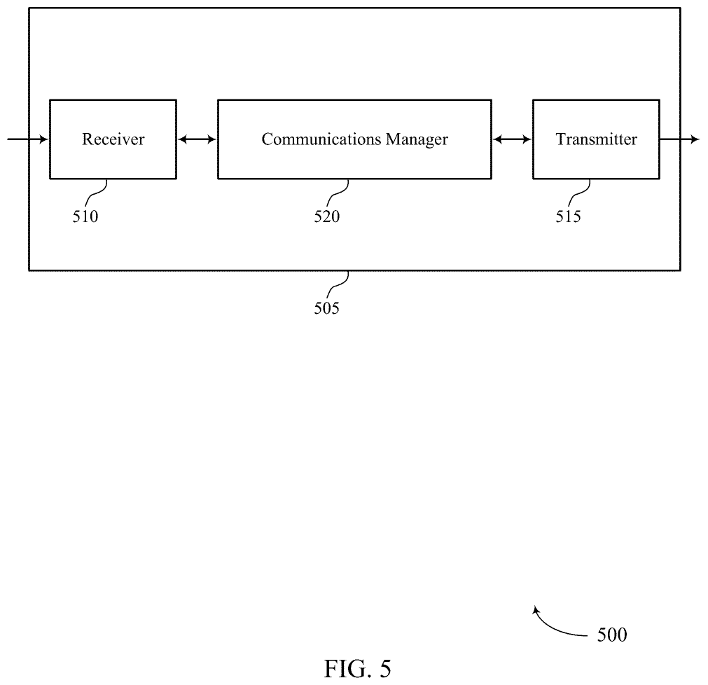

FIG. 5 shows a block diagram 500 of a device 505 that supports techniques for joint reporting of CSI and CLI in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to joint reporting of CSI and CLI). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to joint reporting of CSI and CLI). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of joint reporting of CSI and CLI as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a network node in accordance with examples as disclosed herein. For example, the communications manager 520 is capable of, configured to, or operable to support a means for receiving a joint configuration indicative of first resources associated with generation of CSI information and second resources associated with generation of CLI (CLI) information. The communications manager 520 is capable of, configured to, or operable to support a means for generating the CSI information and the CLI information in accordance with the joint configuration. The communications manager 520 is capable of, configured to, or operable to support a means for transmitting a joint report indicative of the CSI information and the CLI information.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for joint configuration and joint reporting of CSI and CLI which may result in reduced processing, reduced power consumption, and more efficient utilization of communication resources, among other advantages.

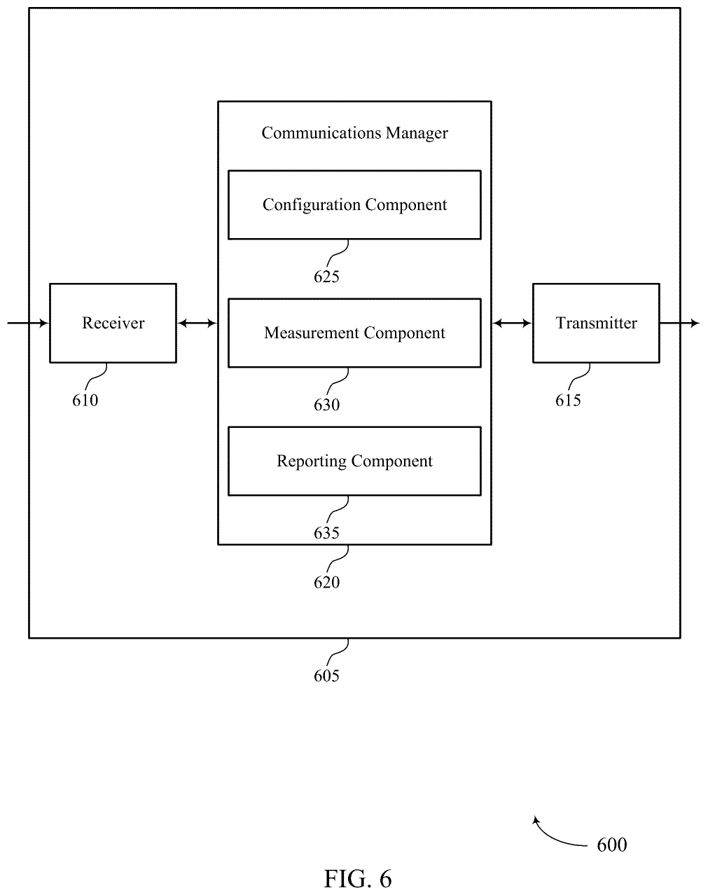

FIG. 6 shows a block diagram 600 of a device 605 that supports techniques for joint reporting of CSI and CLI in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to joint reporting of CSI and CLI). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to joint reporting of CSI and CLI). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of joint reporting of CSI and CLI as described herein. For example, the communications manager 620 may include a configuration component 625, a measurement component 630, a reporting component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a network node in accordance with examples as disclosed herein. The configuration component 625 is capable of, configured to, or operable to support a means for receiving a joint configuration indicative of first resources associated with generation of CSI information and second resources associated with generation of CLI (CLI) information. The measurement component 630 is capable of, configured to, or operable to support a means for generating the CSI information and the CLI information in accordance with the joint configuration. The reporting component 635 is capable of, configured to, or operable to support a means for transmitting a joint report indicative of the CSI information and the CLI information.

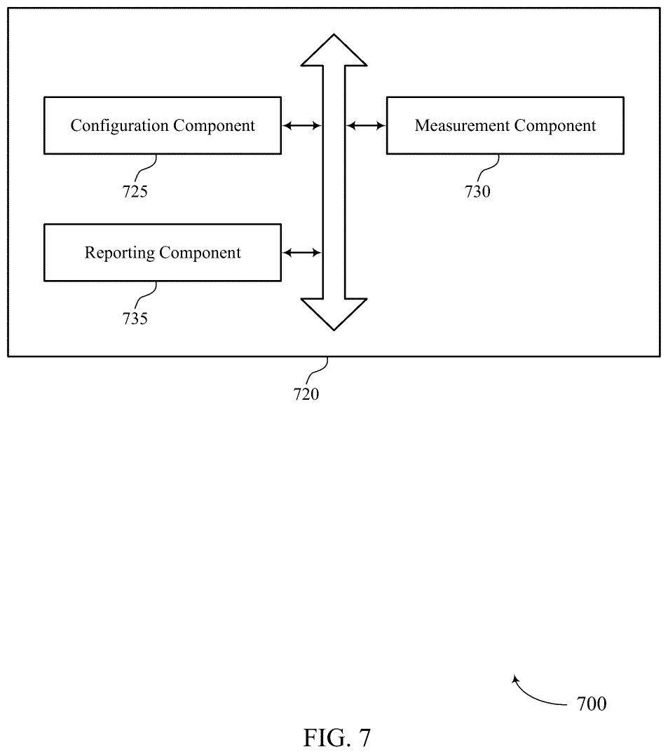

FIG. 7 shows a block diagram 700 of a communications manager 720 that supports techniques for joint reporting of CSI and CLI in accordance with one or more aspects of the present disclosure. The communications manager 720 may be an example of aspects of a communications manager 520, a communications manager 620, or both, as described herein. The communications manager 720, or various components thereof, may be an example of means for performing various aspects of joint reporting of CSI and CLI as described herein. For example, the communications manager 720 may include a configuration component 725, a measurement component 730, a reporting component 735, or any combination thereof. Each of these components may communicate, directly or indirectly, with one another (e.g., via one or more buses).

The communications manager 720 may support wireless communication at a network node in accordance with examples as disclosed herein. The configuration component 725 is capable of, configured to, or operable to support a means for receiving a joint configuration indicative of first resources associated with generation of CSI information and second resources associated with generation of CLI (CLI) information. The measurement component 730 is capable of, configured to, or operable to support a means for generating the CSI information and the CLI information in accordance with the joint configuration. The reporting component 735 is capable of, configured to, or operable to support a means for transmitting a joint report indicative of the CSI information and the CLI information.

In some examples, to support generating the CSI information and the CLI information in accordance with the joint configuration, the measurement component 730 is capable of, configured to, or operable to support a means for measuring the first resources to generate one or more CSI metrics, where the CSI information includes the one or more CSI metrics. In some examples, to support generating the CSI information and the CLI information in accordance with the joint configuration, the measurement component 730 is capable of, configured to, or operable to support a means for measuring the second resources to generate one or more CLI metrics, where the CLI information includes the one or more CLI metrics.

In some examples, the one or more CLI metrics includes one or more RSSIs, one or more RSRPs, one or more SINRs, or any combination thereof.

In some examples, the one or more CSI metrics includes one or more CQIs, one or more RIs, one or more PMIs, one or more CRIs, or any combination thereof.

In some examples, the joint configuration includes a wideband format indicator or a sub-band format indicator associated with generation of the one or more CLI metrics.

In some examples, to support measuring the second resources, the measurement component 730 is capable of, configured to, or operable to support a means for measuring the second resources over a wideband to generate a first CLI metric associated with the wideband based on the joint configuration including the wideband format indicator, where the one or more CLI metrics includes the first CLI metric.

In some examples, to support measuring the second resources, the measurement component 730 is capable of, configured to, or operable to support a means for measuring the second resources over a set of sub-bands to generate a set of first CLI metrics associated with each sub-band of the set of sub-bands based on the joint configuration including the sub-band format indicator, where the one or more CLI metrics includes the set of first CLI metrics.

In some examples, to support generating the CSI information and the CLI information in accordance with the joint configuration, the measurement component 730 is capable of, configured to, or operable to support a means for measuring the first resources and the second resources to generate one or more CSI metrics, where the CSI information includes the one or more CSI metrics. In some examples, to support generating the CSI information and the CLI information in accordance with the joint configuration, the measurement component 730 is capable of, configured to, or operable to support a means for measuring the second resources to generate one or more CLI metrics, where the CLI information includes the one or more CLI metrics.

In some examples, the CSI information is first CSI information associated with a first slot. In some examples, the joint report includes the first CSI information as one or more differential values with respect to second CSI information associated with a second slot that is prior to the first slot.

In some examples, the first slot is a SBFD slot and the second slot is a non-SBFD slot.

In some examples, the first slot is an asynchronous slot and the second slot is a synchronous slot.

In some examples, the CLI information is first CLI information associated with a first slot. In some examples, the joint report includes the first CLI information as one or more differential values with respect to second CLI information associated with a second slot that is prior to the first slot.

In some examples, at least a subset of the first resources are the same as the second resources.

In some examples, the first resources are different than the second resources.

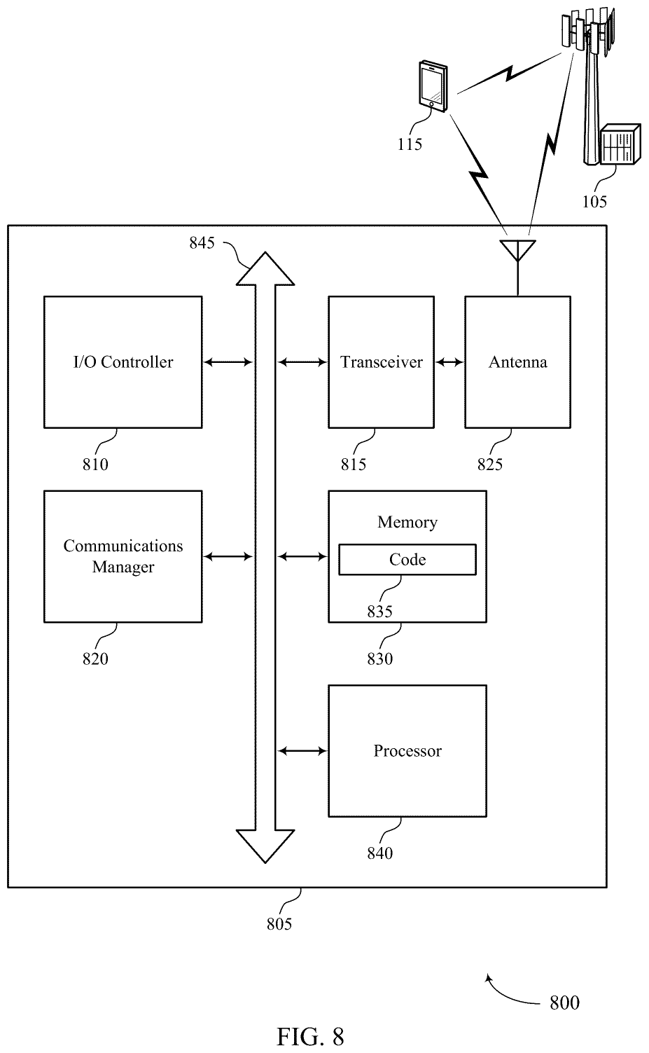

FIG. 8 shows a diagram of a system 800 including a device 805 that supports techniques for joint reporting of CSI and CLI in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting joint reporting of CSI and CLI). For example, the device 805 or a component of the device 805 may include a processor 840 and memory 830 coupled with or to the processor 840, the processor 840 and memory 830 configured to perform various functions described herein.

The communications manager 820 may support wireless communication at a network node in accordance with examples as disclosed herein. For example, the communications manager 820 is capable of, configured to, or operable to support a means for receiving a joint configuration indicative of first resources associated with generation of CSI information and second resources associated with generation of CLI (CLI) information. The communications manager 820 is capable of, configured to, or operable to support a means for generating the CSI information and the CLI information in accordance with the joint configuration. The communications manager 820 is capable of, configured to, or operable to support a means for transmitting a joint report indicative of the CSI information and the CLI information.

By including or configuring the communications manager 820 in accordance with examples as described herein, the device 805 may support joint configuration and joint reporting of CSI and CLI which may result in improved communication reliability, reduced latency, improved user experience related to reduced processing, reduced power consumption, more efficient utilization of communication resources, improved coordination between devices, longer battery life, improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of joint reporting of CSI and CLI as described herein, or the processor 840 and the memory 830 may be otherwise configured to perform or support such operations.

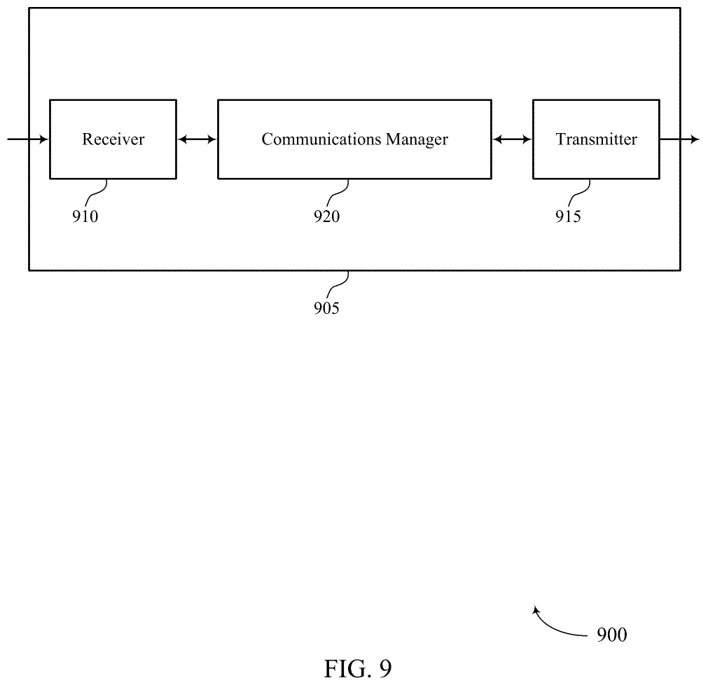

FIG. 9 shows a block diagram 900 of a device 905 that supports joint reporting of CSI and CLI in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of joint reporting of CSI and CLI as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network node in accordance with examples as disclosed herein. For example, the communications manager 920 is capable of, configured to, or operable to support a means for transmitting a joint configuration indicative of first resources associated with generation of CSI information and second resources associated with generation of CLI (CLI) information. The communications manager 920 is capable of, configured to, or operable to support a means for receiving a joint report indicative of the CSI information and the CLI information in accordance with the joint configuration.

By including or configuring the communications manager 920 in accordance with examples as described herein, the device 905 (e.g., a processor controlling or otherwise coupled with the receiver 910, the transmitter 915, the communications manager 920, or a combination thereof) may support joint configuration and joint reporting of CSI and CLI which may result in reduced processing, reduced power consumption, and more efficient utilization of communication resources, among other advantages.

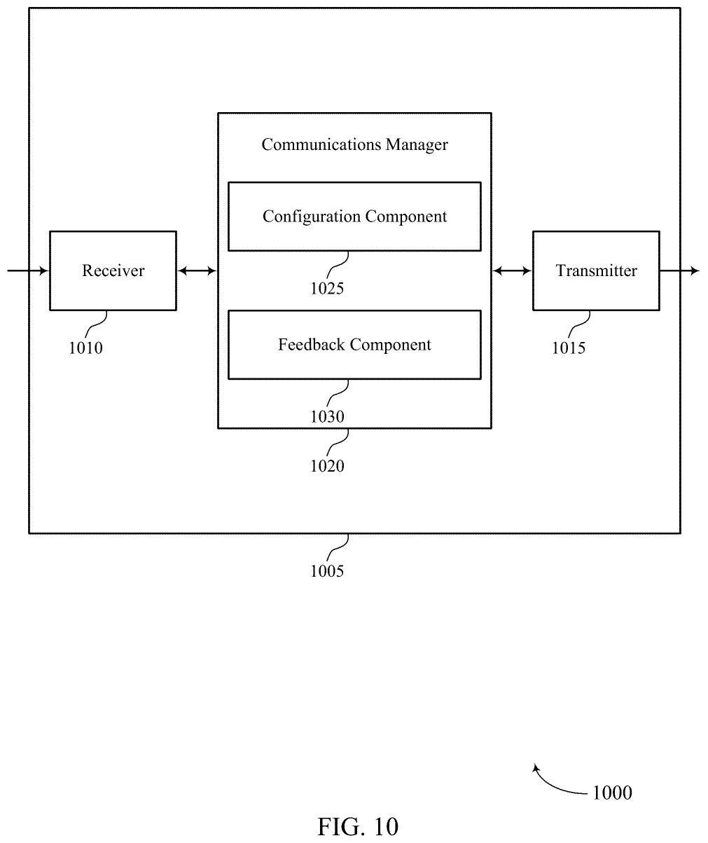

FIG. 10 shows a block diagram 1000 of a device 1005 that supports joint reporting of CSI and CLI in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of joint reporting of CSI and CLI as described herein. For example, the communications manager 1020 may include a configuration component 1025 a feedback component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network node in accordance with examples as disclosed herein. The configuration component 1025 is capable of, configured to, or operable to support a means for transmitting a joint configuration indicative of first resources associated with generation of CSI information and second resources associated with generation of CLI (CLI) information. The feedback component 1030 is capable of, configured to, or operable to support a means for receiving a joint report indicative of the CSI information and the CLI information in accordance with the joint configuration.

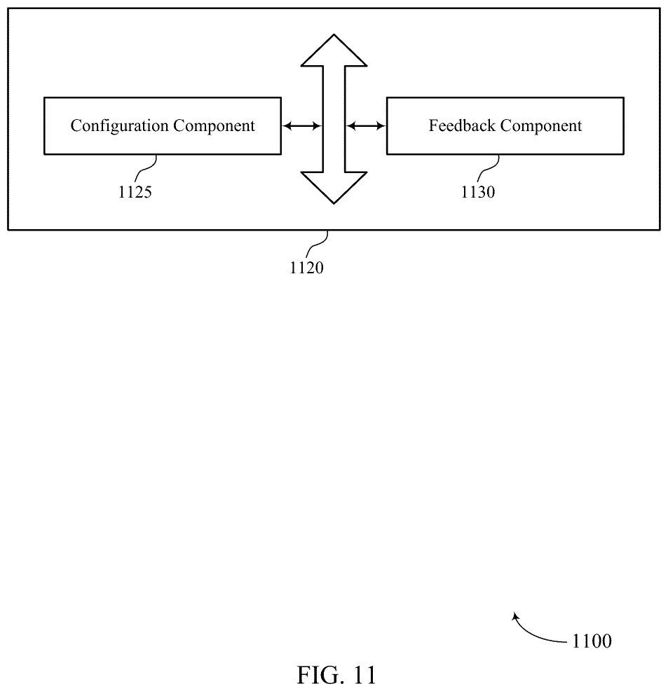

FIG. 11 shows a block diagram 1100 of a communications manager 1120 that supports joint reporting of CSI and CLI in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of joint reporting of CSI and CLI as described herein. For example, the communications manager 1120 may include a configuration component 1125 a feedback component 1130, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network node in accordance with examples as disclosed herein. The configuration component 1125 is capable of, configured to, or operable to support a means for transmitting a joint configuration indicative of first resources associated with generation of CSI information and second resources associated with generation of CLI (CLI) information. The feedback component 1130 is capable of, configured to, or operable to support a means for receiving a joint report indicative of the CSI information and the CLI information in accordance with the joint configuration.

In some examples, the CSI information includes one or more CSI metrics. In some examples, the CLI information includes one or more CLI metrics.

In some examples, the one or more CLI metrics includes one or more RSSIs, one or more RSRPs, one or more SINRs, or any combination thereof.

In some examples, the one or more CSI metrics includes one or more CQIs, one or more RIs, one or more PMIs, one or more CRIs, or any combination thereof.

In some examples, the joint configuration includes a wideband format indicator or a sub-band format indicator associated with generation of the one or more CLI metrics.

In some examples, the first resources are associated with a wideband. In some examples, the one or more CLI metrics includes a first CSI metric associated with the wideband based on the joint configuration including the wideband format indicator.

In some examples, the first resources are associated with a set of sub-bands. In some examples, the one or more CLI metrics includes a first CSI metric associated with each sub-band based on the joint configuration including the sub-band format indicator.

In some examples, the CSI information is first CSI information associated with a first slot. In some examples, the joint report includes the first CSI information as one or more differential values with respect to second CSI information associated with a second slot that is prior to the first slot.

In some examples, the first slot is a SBFD slot and the second slot is a non-SBFD slot.

In some examples, the first slot is an asynchronous slot and the second slot is a synchronous slot.

In some examples, the CLI information is first CLI information associated with a first slot. In some examples, the joint report includes the first CLI information as one or more differential values with respect to second CLI information associated with a second slot that is prior to the first slot.

In some examples, at least a subset of the first resources are the same as the second resources.

In some examples, the first resources are different than the second resources.

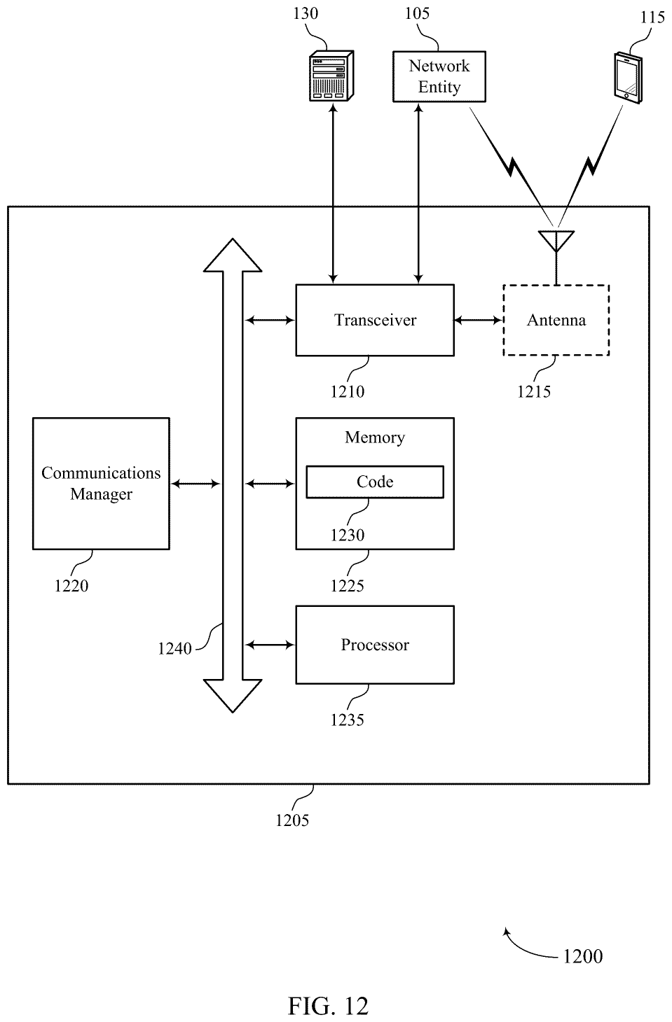

FIG. 12 shows a diagram of a system 1200 including a device 1205 that supports joint reporting of CSI and CLI in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting joint reporting of CSI and CLI). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communication network technology to provide communication between network entities 105.

The communications manager 1220 may support wireless communication at a network node in accordance with examples as disclosed herein. For example, the communications manager 1220 is capable of, configured to, or operable to support a means for transmitting a joint configuration indicative of first resources associated with generation of CSI information and second resources associated with generation of CLI (CLI) information. The communications manager 1220 is capable of, configured to, or operable to support a means for receiving a joint report indicative of the CSI information and the CLI information in accordance with the joint configuration.

By including or configuring the communications manager 1220 in accordance with examples as described herein, the device 1205 may support tech joint configuration and joint reporting of CSI and CLI which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of joint reporting of CSI and CLI as described herein, or the processor 1235 and the memory 1225 may be otherwise configured to perform or support such operations.

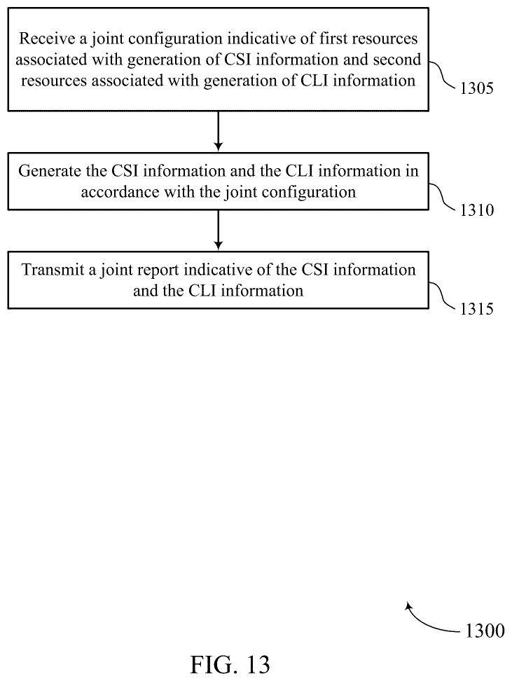

FIG. 13 shows a flowchart illustrating a method 1300 that supports joint reporting of CSI and CLI in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a joint configuration indicative of first resources associated with generation of CSI information and second resources associated with generation of CLI (CLI) information. The operations of block 1305 may be performed in accordance with examples as disclosed herein. In some examples, aspects of the operations of 1305 may be performed by a configuration component 725 as described with reference to FIG. 7.

At 1310, the method may include generating the CSI information and the CLI information in accordance with the joint configuration. The operations of block 1310 may be performed in accordance with examples as disclosed herein. In some examples, aspects of the operations of 1310 may be performed by a measurement component 730 as described with reference to FIG. 7.

At 1315, the method may include transmitting a joint report indicative of the CSI information and the CLI information. The operations of block 1315 may be performed in accordance with examples as disclosed herein. In some examples, aspects of the operations of 1315 may be performed by a reporting component 735 as described with reference to FIG. 7.

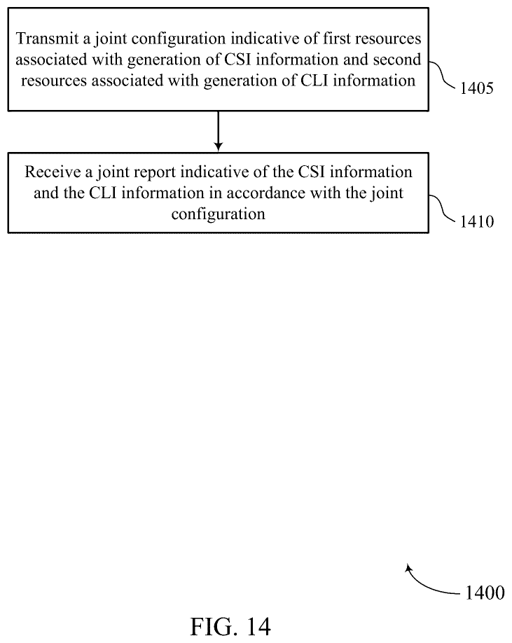

FIG. 14 shows a flowchart illustrating a method 1400 that supports joint reporting of CSI and CLI in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a joint configuration indicative of first resources associated with generation of CSI information and second resources associated with generation of CLI (CLI) information. The operations of block 1405 may be performed in accordance with examples as disclosed herein. In some examples, aspects of the operations of 1405 may be performed by a configuration component 1125 as described with reference to FIG. 11.

At 1410, the method may include receiving a joint report indicative of the CSI information and the CLI information in accordance with the joint configuration. The operations of block 1410 may be performed in accordance with examples as disclosed herein. In some examples, aspects of the operations of 1410 may be performed by a feedback component 1130 as described with reference to FIG. 11.

The following provides an overview of aspects of the present disclosure:

Aspect 1: A method for wireless communications at a network node, comprising: receiving a joint configuration indicative of first resources associated with generation of CSI information and second resources associated with generation of CLI information; generating the CSI information and the CLI information in accordance with the joint configuration; and transmitting a joint report indicative of the CSI information and the CLI information.

Aspect 2: The method of aspect 1, wherein generating the CSI information and the CLI information in accordance with the joint configuration comprises: measuring the first resources to generate one or more CSI metrics, wherein the CSI information comprises the one or more CSI metrics; and measuring the second resources to generate one or more CLI metrics, wherein the CLI information comprises the one or more CLI metrics.

Aspect 3: The method of aspect 2, wherein the one or more CLI metrics comprises one or more RSSIs, one or more RSRPs, one or more SINRs, or any combination thereof.

Aspect 4: The method of any of aspects 2 through 3, wherein the one or more CSI metrics comprises one or more CQIs indicators, one or more RIs, one or more PMIs, one or more CRIs, or any combination thereof.

Aspect 5: The method of any of aspects 2 through 4, wherein the joint configuration comprises a wideband format indicator or a sub-band format indicator associated with generation of the one or more CLI metrics.

Aspect 6: The method of aspect 5, wherein measuring the second resources comprises: measuring the second resources over a wideband to generate a first CLI metric associated with the wideband based on the joint configuration comprising the wideband format indicator, wherein the one or more CLI metrics comprises the first CLI metric.

Aspect 7: The method of aspect 5, wherein measuring the second resources comprises: measuring the second resources over a set of sub-bands to generate a set of first CLI metrics associated with each sub-band of the set of sub-bands based on the joint configuration comprising the sub-band format indicator, wherein the one or more CLI metrics comprises the set of first CLI metrics.

Aspect 8: The method of any of aspects 1 through 7, wherein generating the CSI information and the CLI information in accordance with the joint configuration comprises: measuring the first resources and the second resources to generate one or more CSI metrics, wherein the CSI information comprises the one or more CSI metrics; and measuring the second resources to generate one or more CLI metrics, wherein the CLI information comprises the one or more CLI metrics.

Aspect 9: The method of any of aspects 1 through 8, wherein the CSI information is first CSI information associated with a first slot, and the joint report includes the first CSI information as one or more differential values with respect to second CSI information associated with a second slot that is prior to the first slot

Aspect 10: The method of aspect 9, wherein the first slot is a SBFD slot and the second slot is a non-SBFD slot.

Aspect 11: The method of any of aspects 9 through 10, wherein the first slot is an asynchronous slot and the second slot is a synchronous slot.

Aspect 12: The method of any of aspects 1 through 11, wherein the CLI information is first CLI information associated with a first slot, and the joint report includes the first CLI information as one or more differential values with respect to second CLI information associated with a second slot that is prior to the first slot.

Aspect 13: The method of any of aspects 1 through 12, wherein at least a subset of the first resources are the same as the second resources.

Aspect 14: The method of any of aspects 1 through 13, wherein the first resources are different than the second resources.

Aspect 15: A method for wireless communications at a network node, comprising: transmitting a joint configuration indicative of first resources associated with generation of CSI information and second resources associated with generation of CLI information; and receiving a joint report indicative of the CSI information and the CLI information in accordance with the joint configuration.

Aspect 16: The method of aspect 15, wherein the CSI information comprises one or more CSI metrics, and the CLI information comprises one or more CLI metrics.

Aspect 17: The method of aspect 16, wherein the one or more CLI metrics comprises one or more RSSIs, one or more RSRPs, one or more SINRs, or any combination thereof.

Aspect 18: The method of any of aspects 16 through 17, wherein the one or more CSI metrics comprises one or more CQIs indicators, one or more RIs, one or more PMIs, one or more CRIs, or any combination thereof.

Aspect 19: The method of any of aspects 16 through 18, wherein the joint configuration comprises a wideband format indicator or a sub-band format indicator associated with generation of the one or more CLI metrics.

Aspect 20: The method of aspect 19, wherein the first resources are associated with a wideband, and the one or more CLI metrics comprises a first CSI metric associated with the wideband based on the joint configuration comprising the wideband format indicator.

Aspect 21: The method of aspect 19, wherein the first resources are associated with a set of sub-bands, and the one or more CLI metrics comprises a first CSI metric associated with each sub-band based on the joint configuration comprising the sub-band format indicator.

Aspect 22: The method of any of aspects 15 through 21, wherein the CSI information is first CSI information associated with a first slot, and the joint report includes the first CSI information as one or more differential values with respect to second CSI information associated with a second slot that is prior to the first slot

Aspect 23: The method of aspect 22, wherein the first slot is a SBFD slot and the second slot is a non-SBFD slot.

Aspect 24: The method of any of aspects 22 through 23, wherein the first slot is an asynchronous slot and the second slot is a synchronous slot.

Aspect 25: The method of any of aspects 15 through 24, wherein the CLI information is first CLI information associated with a first slot, and the joint report includes the first CLI information as one or more differential values with respect to second CLI information associated with a second slot that is prior to the first slot.

Aspect 26: The method of any of aspects 15 through 25, wherein at least a subset of the first resources are the same as the second resources.

Aspect 27: The method of any of aspects 15 through 26, wherein the first resources are different than the second resources.

Aspect 28: An apparatus for wireless communications at a network node, comprising a processor; memory coupled with the processor; and instructions stored in the memory and executable by the processor to cause the apparatus to perform a method of any of aspects 1 through 14.

Aspect 29: An apparatus for wireless communications at a network node, comprising at least one means for performing a method of any of aspects 1 through 14.

Aspect 30: A non-transitory computer-readable medium storing code for wireless communications at a network node, the code comprising instructions executable by a processor to perform a method of any of aspects 1 through 14.

Aspect 31: An apparatus for wireless communications at a network node, comprising a processor; memory coupled with the processor; and instructions stored in the memory and executable by the processor to cause the apparatus to perform a method of any of aspects 15 through 27.

Aspect 32: An apparatus for wireless communications at a network node, comprising at least one means for performing a method of any of aspects 15 through 27.

Aspect 33: A non-transitory computer-readable medium storing code for wireless communications at a network node, the code comprising instructions executable by a processor to perform a method of any of aspects 15 through 27.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node for wireless communication, comprising:
a memory; and
at least one processor coupled to the memory, wherein the at least one processor is configured to:
receive a joint configuration indicative of first resources associated with generation of channel state information (CSI) information and second resources associated with generation of cross-link interference (CLI) information;
generate the CSI information and the CLI information in accordance with the joint configuration; and
transmit a joint report indicative of the CSI information and the CLI information.

2. The first network node of claim 1, wherein, to generate the CSI information and the CLI information in accordance with the joint configuration, the at least one processor is configured to:
measure the first resources to generate one or more CSI metrics, wherein the CSI information comprises the one or more CSI metrics; and
measure the second resources to generate one or more CLI metrics, wherein the CLI information comprises the one or more CLI metrics.

3. The first network node of claim 2, wherein the one or more CLI metrics comprises one or more received signal strength indicators, one or more reference signal received powers, one or more signal to interference and noise ratios, or any combination thereof.

4. The first network node of claim 2, wherein the one or more CSI metrics comprises one or more channel quality indicators, one or more rank indicators, one or more pre-coding matrix indicators, one or more CSI-reference signal reference indicators, or any combination thereof.

5. The first network node of claim 2, wherein the joint configuration comprises a wideband format indicator or a sub-band format indicator associated with generation of the one or more CLI metrics.

6. The first network node of claim 5, wherein, to measure the second resources, the at least one processor is configured to:
measure the second resources over a wideband to generate a first CLI metric associated with the wideband based on the joint configuration comprising the wideband format indicator, wherein the one or more CLI metrics comprises the first CLI metric.

7. The first network node of claim 5, wherein, to measure the second resources, the at least one processor is configured to:
measure the second resources over a set of sub-bands to generate a set of first CLI metrics associated with each sub-band of the set of sub-bands based on the joint configuration comprising the sub-band format indicator, wherein the one or more CLI metrics comprises the set of first CLI metrics.

8. The first network node of claim 1, wherein, to generate the CSI information and the CLI information in accordance with the joint configuration, the at least one processor is configured to:
measure the first resources and the second resources to generate one or more CSI metrics, wherein the CSI information comprises the one or more CSI metrics; and
measure the second resources to generate one or more CLI metrics, wherein the CLI information comprises the one or more CLI metrics.

9. The first network node of claim 1, wherein the CSI information is first CSI information associated with a first slot, and wherein the joint report includes the first CSI information as one or more differential values with respect to second CSI information associated with a second slot that is prior to the first slot.

10. The first network node of claim 9, wherein the first slot is a sub-band full duplex slot and the second slot is a non-sub-band full duplex slot.

11. The first network node of claim 9, wherein the first slot is an asynchronous slot and the second slot is a synchronous slot.

12. The first network node of claim 1, wherein the CLI information is first CLI information associated with a first slot, and wherein the joint report includes the first CLI information as one or more differential values with respect to second CLI information associated with a second slot that is prior to the first slot.

13. The first network node of claim 1, wherein at least a subset of the first resources are the same as the second resources.

14. The first network node of claim 1, wherein the first resources are different than the second resources.

15. A method of wireless communication performed by a first network node, comprising:
receiving a joint configuration indicative of first resources associated with generation of channel state information (CSI) information and second resources associated with generation of cross-link interference (CLI) information;
generating the CSI information and the CLI information in accordance with the joint configuration; and
transmitting a joint report indicative of the CSI information and the CLI information.

16. The method of claim 15, wherein generating the CSI information and the CLI information in accordance with the joint configuration comprises:
measuring the first resources to generate one or more CSI metrics, wherein the CSI information comprises the one or more CSI metrics; and
measuring the second resources to generate one or more CLI metrics, wherein the CLI information comprises the one or more CLI metrics.

17. The method of claim 15, wherein generating the CSI information and the CLI information in accordance with the joint configuration comprises:
measuring the first resources and the second resources to generate one or more CSI metrics, wherein the CSI information comprises the one or more CSI metrics; and
measuring the second resources to generate one or more CLI metrics, wherein the CLI information comprises the one or more CLI metrics.

18. The method of claim 15, wherein the CSI information is first CSI information associated with a first slot, and wherein the joint report includes the first CSI information as one or more differential values with respect to second CSI information associated with a second slot that is prior to the first slot.

19. The method of claim 15, wherein the CLI information is first CLI information associated with a first slot, and wherein the joint report includes the first CLI information as one or more differential values with respect to second CLI information associated with a second slot that is prior to the first slot.

20. A first network node for wireless communication, comprising:
means for receiving a joint configuration indicative of first resources associated with generation of channel state information (CSI) information and second resources associated with generation of cross-link interference (CLI) information;
means for generating the CSI information and the CLI information in accordance with the joint configuration; and
means for transmitting a joint report indicative of the CSI information and the CLI information.
